(19) United States
(12) Patent Application Publication
(10) Pub. No.: US 2026/0170972 A1
(43) Pub. Date: Jun. 18, 2026

(54) ENGINE FAILURE TRAINING METHOD FOR A SINGLE-ENGINE ROTORCRAFT

(71) Applicant: AIRBUS HELICOPTERS, Marignane Cedex (FR)

(72) Inventors: Guillaume DUMUR, Salon De Provence (FR); Marc PRUNEL, Marignane Cedex (FR); Bernard CALABRESE, Marignane Cedex (FR)

(73) Assignee: AIRBUS HELICOPTERS, Marignane Cedex (FR)

(21) Appl. No.: 19/300,532

(22) Filed: Aug. 14, 2025

(30) Foreign Application Priority Data
Dec. 13, 2024 (FR) FR2414128

(51) Int. Cl. G09B 9/08; G09B 9/46

(52) U.S. Cl. CPC G09B 9/085; G09B 9/46

(57) ABSTRACT

A method for simulating a failure of a combustion engine of a single-engine rotorcraft, the rotorcraft comprising a controller controlling the combustion engine. The method comprises: i) arming a training mode by operating an arming button in communication with the controller, the training mode not being able to be activated in the absence of the arming of the training mode; ii) subject to the arming, activating the training mode by operating an activation button that is in communication with the controller, the controller consequently controlling a deceleration of the combustion engine to reach the idling speed; iii) deactivating the training mode by operating the activation button again, the controller consequently controlling an acceleration of the combustion engine to reach a flight speed, the training mode being able to be reset only during a new simulation phase.

### CROSS REFERENCE TO RELATED APPLICATIONS

This application claims priority to French patent application No. FR 24 14128 filed on Dec. 13, 2024, the disclosure of which is incorporated in its entirety by reference herein.

### TECHNICAL FIELD

The present disclosure relates to a method for engine failure training on a single-engine rotorcraft.

### BACKGROUND

A rotorcraft conventionally comprises a power plant for setting in motion at least one rotor contributing to its lift. For the sake of convenience, such a rotor is referred to hereinafter as a “lift rotor”. For example, a helicopter may comprise a lift rotor and a rear rotor that helps to control the yaw movement of the helicopter.

The power plant may comprise at least one combustion engine. For the sake of convenience, the expression “combustion engine” designates an engine that requires the combustion of a fuel in order to produce mechanical energy, such as a turboshaft engine or a piston engine, for example. The expression “combustion engine” is used in contrast to the term “electric motor”, that describes motors that transform electrical energy into mechanical energy.

Thus, a single-engine rotorcraft comprises a single combustion engine for setting in motion a drive chain connected to the rotor or rotors.

The operation of the combustion engine is controlled by a regulation system. By way of example, a regulation system is known by the acronym FADEC for Full Authority Digital Engine Control. A regulation system conventionally comprises an engine computer connected to various sensors and a fuel metering device. The fuel metering device then allows the regulation system to control the flow of fuel transmitted to the combustion engine in order to be injected into a combustion chamber with an oxidant.

The regulation system conventionally comprises a selector, called “control selector” for convenience, in order to establish the operating speed to be applied. For example, the control selector may have three positions.

When the control selector is in one position, e.g., referred to as its “STOP position”, the combustion engine is turned off.

When the control selector is in a position, e.g., referred to as its “FLIGHT position”, the combustion engine is in nominal operation. The combustion engine can then operate by implementing a conventional flight speed. The combustion engine develops a driving power for setting in motion the drive chain, and consequently the rotor or rotors.

Finally, the control selector has a third position, e.g., referred to as its “IDLE position”. When the control selector is positioned in this IDLE position, the combustion engine operates at an idling speed. During the application of the idling speed, the combustion engine outputs an idling driving power that is less than the powers output during the application of the flight speeds, or even a zero engine power.

Optionally, a rotorcraft may also comprise a rotating throttle to require the combustion engine to idle.

A rotorcraft may comprise dual piloting controls to enable training of a student. The rotorcraft may then comprise a control selector, and two rotating throttle handles.

If a combustion engine fails on a conventional single-engine rotorcraft, the lift rotor is no longer driven by this combustion engine. The speed of rotation of the lift rotor then undergoes a significant deceleration. The aircraft then needs to be controlled by a pilot to enter an autorotation flight phase in order to limit the reduction in the speed of rotation of the lift rotor.

This entry into the autorotation flight phase must be made within a very short time in order to maintain an acceptable speed of rotation of the lift rotor. An autorotation flight phase is a particular flight phase wherein the aircraft flies in a descending direction without driving power. On a helicopter of the type described above, the lift rotor is then rotated by the relative wind. The lift rotor provides sufficient stabilized lift to brake and control the descent of the aircraft until it lands. In order to apply this particular piloting procedure, the pilot needs to enter the autorotation phase by quickly reducing the collective pitch of the blades of the lift rotor in order to keep the speed of rotation of the lift rotor within permissible limits. This particular procedure calls for a high degree of accuracy and appropriate, recurrent training for the pilots. Carrying out such training is challenging. During such training, an instructor or his student places the combustion engine in idling speed in order to simulate engine failure. The instructor or his student moves, for example, a rotating throttle to an idle mechanical stop. If necessary, the instructor or his student can move the rotating throttle at any time to re-accelerate the combustion engine.

Thus, if the instructor decides to end the training if he deems it necessary for the safety of the flight, the instructor moves his rotating handle in order to re-accelerate the combustion engine. However, the student must not misinterpret the re-acceleration and request again a change to idle mode.

To this end, the rotating throttles are connected to one another by a synchronization mechanism. A movement of one rotating throttle actually induces the same movement on the other rotating throttle. Thus, each pilot is notified immediately, that the other pilot has initiated a command with a rotating throttle. Although effective, such a system is heavy and cumbersome.

Document EP 4 450 399 A1 describes a method for simulating an engine failure on a rotorcraft, the rotorcraft comprising a power plant provided with a plurality of engines.

Document CN115762292 is far removed from the problem of the disclosure by describing a helicopter having two engines respectively controlled by two control systems. In addition, the two control systems are respectively connected to two controls each able to require the application of a training mode. A training mode is implemented when both control systems are not faulty and both controls are in a FLIGHT position.

The same applies to the document present on 7 Nov. 2024 at the internet address https: ardupilot. org/copter/docs/traditional-helicopter-autorotation-mode. html that describes autorotation modes of unmanned aircraft.

Documents EP 4 446 232 A1, EP 3 733 508 A1, CN 112 216 181 A and CA 3 064 098 C are also known and far removed from the problem of the disclosure.

### SUMMARY

An object of the present disclosure is therefore to propose an innovative method for securing the implementation of engine-failure training on a single-engine rotorcraft.

The disclosure thus relates to a method for simulating a failure of a combustion engine of a single-engine rotorcraft, the rotorcraft comprising a controller controlling the combustion engine, the combustion engine being able to operate on command from the controller in a nominal mode at at least one flight speed in order to provide a driving power to at least one rotor, the combustion engine being able to operate on command from the controller at an idling speed.

This method comprises a simulation phase having the following steps:
arming a training mode by operating an arming button in communication with the controller, the controller controlling an operation of the combustion engine according to at least one flight speed, the training mode not being able to be activated in the absence of said arming of the training mode;
subject to said arming of the training mode, activating the training mode by operating an activation button that is in communication with the controller and different from the arming button, the controller consequently controlling a deceleration of the combustion engine to reach said idling speed; and
deactivating the training mode by operating the activation button again, the controller consequently controlling an acceleration of the combustion engine to reach the at least one flight speed, the training mode being able to be reset only during a new simulation phase.

Thus, the arming button simply authorizes the use of training mode, but does not allow the activation of the training mode. A pilot, and for example an instructor or his student, can then operate this arming button.

When the training mode is armed, the instructor or student can operate the activation button. The training mode is then automatically activated. The combustion engine is then decelerated by the controller to operate at idle in order to simulate a failure. For example, since the combustion engine has a power shaft mechanically and kinematically connected to the rotor, this power shaft is decelerated by reducing the flow of fuel supplying the combustion engine. A second press of the activation button automatically orders the acceleration of the combustion engine. According to the previous example, the speed of rotation of the power shaft is increased by increasing the flow rate of fuel supplied to the combustion engine. Thus, an instructor can re-accelerate the combustion engine if he deems it necessary. On the other hand, the student cannot accidentally return the combustion engine to idle following a re-acceleration. Indeed, a new operation of the activation button has no consequence on the driving power generated by the combustion engine until a new simulation phase has been initiated, either by disarming the training mode and then rearming a new training mode, via a double application of the arming button, or simply by rearming a new training mode via a single application of the arming button according to the variant. Thus, to simulate the engine failure again, it is necessary in this case to press the arming button at least once to initiate a new simulation phase.

This method then tends to limit the risks of accidental idling of the combustion engine on a single-engine rotorcraft by implementing an engine failure simulation training mode. This method can be implemented in a simple, space-saving and lightweight manner. This method may optionally make it possible to avoid having to arrange rotating throttles.

The method may comprise one or more of the following features, taken individually or in combination.

Thus, the simulation phase may comprise disarming by operating the arming button at any time after said arming of the training mode, the disarming ending the simulation phase, and if the combustion engine is at idling speed, then, following the disarming, the controller controls an acceleration of the combustion engine in order to reach said at least one flight speed.

At any time, the disarming can be engaged and lead to the automatic operation of the combustion engine at a flight speed.

According to one possibility compatible with the preceding possibilities, the method may comprise generating an arming alert with an alerter as long as said training mode is armed.

A visual alert is, for example, issued on a display of the rotorcraft to signal to the crew that the training mode is armed.

The disclosure also relates to a rotorcraft implementing such a method for simulating an engine failure on a single-engine rotorcraft.

Such a single-engine rotorcraft comprises a single combustion engine for setting in motion a drive chain connected to at least one rotor, the rotorcraft comprising a controller controlling the combustion engine, the combustion engine being able to operate on command from the controller in a nominal mode at at least one flight speed in order to provide a driving power to at least one rotor, the combustion engine being able to operate on command from the controller at an idling speed.

The rotorcraft comprises an arming button and at least one activation button both connected to the controller in order to implement the method described above.

The rotorcraft may comprise one or more of the following features, taken individually or in combination.

Thus, the rotorcraft may comprise an alerter connected to the controller in order to generate an arming alert following the arming of the training mode.

According to one possibility compatible with the preceding possibilities, the rotorcraft may comprise two activation buttons configured to be respectively operable by two pilots.

It is possible to arrange a single arming button to arm the training mode, and one activation button per pilot. The activation buttons can be arranged on conventional flight controls. For example, the arming button is placed on a console separating two pilots. Optionally, the activation buttons may be placed on control sticks for a cyclic pitch of the blades of a rotor.

According to one possibility compatible with the preceding possibilities, said at least one activation button may be a monostable button.

Such an activation button can ensure that the activation button is not in a position that does not correspond to the current situation.

According to one possibility compatible with the preceding possibilities, said at least one arming button may be a monostable button or a bistable button.

In the presence of a monostable arming button, a single press of the arming button makes it possible to arm a new simulation phase after deactivation.

If a bistable arming button is present, it may be necessary to press the arming button once to disarm the current training mode and again to rearm the training mode.

According to one possibility compatible with the preceding possibilities, said controller may comprise an engine computer controlling the combustion engine, said arming button and said activation button communicating with the engine computer in order to implement the simulation phase.

The conventional engine computer of a combustion engine may, for example, be programmed to apply the method of the disclosure. This method can then be applied in a simple manner to an existing helicopter. The engine computer identifies the speed to be applied as a function of the position of the control selector, then determines whether the training mode is armed by receiving a signal from the arming button, then operates the method as a function of the signal emitted by the activation button or buttons, according to the preceding logic.

Alternatively, said controller may comprise an avionics computer and an engine computer controlling the combustion engine, said arming button and said activation button communicating with the avionics computer, the avionics computer communicating with the engine computer in order to implement the simulation phase.

In this case, the logic for activating the training mode is stored not in the engine computer, but in the avionics computer. The avionics computer communicates with this engine computer that operates in a conventional manner. A conventional avionics computer may, for example, be programmed to apply the method of the disclosure. Depending on the presses on the arming button and the activation button or buttons, the avionics computer transmits a signal to the engine computer indicating to turn off the combustion engine, to set the combustion engine to idling speed or to operate it at a flight speed. This method can then be applied in a simple manner to an existing helicopter without involving a modification of the engine computer.

Alternatively, said controller may comprise an electromechanical relay mechanism and an engine computer controlling the combustion engine, said arming button and said activation button communicating with the electromechanical relay mechanism, the electromechanical relay mechanism communicating with the engine computer in order to implement the simulation phase.

Arming and activation logics can be produced by wiring and the use of relays. These relays will then control transitions between idling speed and flight speed in a manner that is transparent to the engine computer. Depending on the presses on the arming button and the activation button or buttons, the relay mechanism transmits a signal to the engine computer indicating to turn off the combustion engine, to set the combustion engine to idling speed or to operate it at a flight speed. A simple relay mechanism can be used, for example on an existing rotorcraft, to implement the method of the disclosure easily and at a lower cost.

A six relay mechanism may be sufficient.

For example, the arming button closes a first arming contact and a second arming contact in a first arming position, the arming button closing a third arming contact in a second arming position, the activation button closing a first activation contact and a second activation contact in a first activation position, the activation button closing a third activation contact in a second activation position, the electromechanical relay mechanism comprising:
a first relay provided with a first coil electrically connected to a first output arming terminal of said first arming contact;
a second relay provided with a second coil electrically connected to a second output arming terminal of said third arming contact;
a third relay provided with a third coil electrically connected to the second arming contact and to the second output arming terminal via a contact of the second relay controlled by the second coil;
a fourth relay provided with a fourth coil electrically connected to a first output activation terminal of the first activation contact, a first input activation terminal of the first activation contact being electrically connected to the first output arming terminal via a contact of the first relay controlled by the first coil;
a fifth relay provided with a fifth coil electrically connected to a second output activation terminal of the third activation contact; and
a sixth relay provided with a sixth coil electrically connected to an output deactivation terminal of the second activation contact and to the second output activation terminal via a contact of the fifth relay controlled by the fifth coil, an electrical disarming line being electrically connected to the first coil and comprising a contact of the third relay controlled by the third coil and a contact of the sixth relay controlled by the sixth coil.

### BRIEF DESCRIPTION OF THE DRAWINGS

The disclosure and its advantages appear in greater detail from the following description of examples given by way of illustration with reference to the accompanying figures, wherein:

FIG. 1 is a diagram illustrating a rotorcraft according to the disclosure;

FIG. 2 is a diagram illustrating the method of the disclosure;

FIG. 3 is a diagram illustrating an example rotorcraft controller;

FIG. 4 is a diagram illustrating an example rotorcraft controller;

FIG. 5 is a diagram illustrating an example rotorcraft controller when the combustion engine is turned off;

FIG. 6 is a diagram showing the controller of FIG. 5 when the combustion engine is set to pre-flight idle speed using a control selector;

FIG. 7 is a diagram illustrating the controller of FIG. 5 when the control selector requires application of the flight speed prior to the simulation phase;

FIG. 8 is a diagram illustrating the controller of FIG. 5 when the control selector requires application of the flight speed and the arming button is operated to arm the training mode;

FIG. 9 is a diagram illustrating the controller of FIG. 5 when the control selector requires application of the flight speed and the arming button is released after arming the training mode;

FIG. 10 is a diagram illustrating the controller of FIG. 5 when the control selector requires application of the flight speed and the activation button is applied to activate the training mode and switch the combustion engine to idling speed;

FIG. 11 is a diagram illustrating the controller of FIG. 5 when the control selector requires application of the flight speed and the activation button is released after activation of the training mode;

FIG. 12 is a diagram illustrating the controller of FIG. 5 when the control selector requires application of the flight speed and the activation button is applied to deactivate the training mode; and

FIG. 13 is a diagram illustrating the controller of FIG. 5 when the control selector requires application of the flight speed and the arming button is applied to disarm the training mode.

### DETAILED DESCRIPTION

Elements present in more than one of the figures are given the same references in each of them.

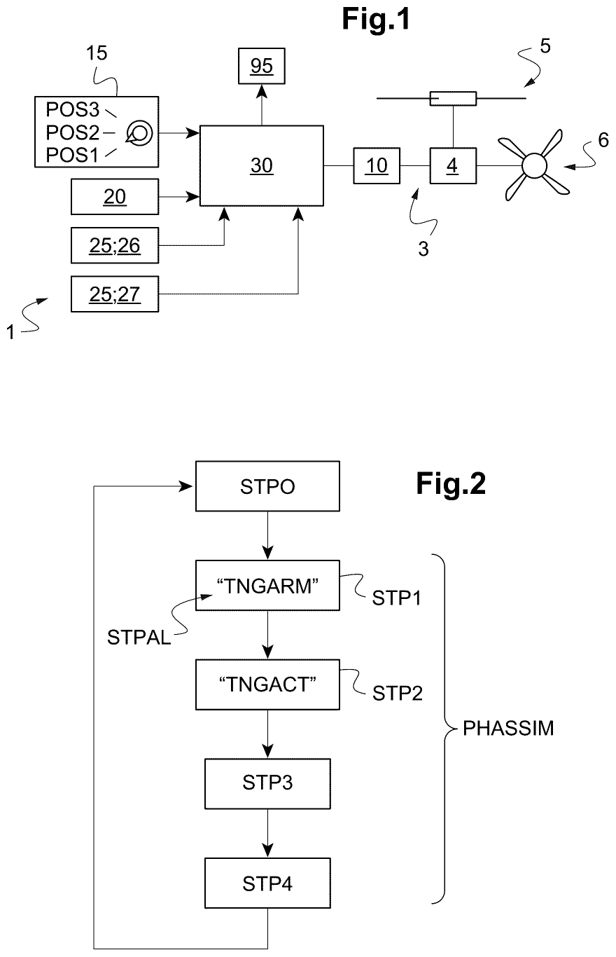

FIG. 1 shows a rotorcraft 1 according to the disclosure. The rotorcraft 1 comprises at least one rotor. Thus, the rotorcraft 1 illustrated is a helicopter having a lift rotor 5 and a tail rotor 6.

In addition, the rotorcraft 1 is single-engine. Thus, the rotorcraft 1 comprises a single combustion engine 10 for setting in motion, using its power shaft, a drive chain 3 mechanically connected to one or more rotors 5, 6. For example, the drive chain 3 comprises a power transmission gearbox 4 mechanically connected to the combustion engine 10 for setting in motion the rotor or rotors 5, 6.

In addition, the rotorcraft 1 comprises a controller 30 controlling the combustion engine 10 in a conventional manner. For example, the controller 30 controls a fuel metering device of the combustion engine 10 in order to control the driving power generated by the combustion engine 10.

The controller 30 may be connected to a three-position control selector 15. When the selector 15 is in a first control position, POS1, the selector 15 transmits a turn-off signal, for example an analog signal, to the controller 30 to control the turning off of the combustion engine 10. When the selector 15 is in a second control position, POS2, the selector 15 transmits an idle signal, for example an analog signal, to the controller 30 to control the application of an idling speed using the combustion engine 10. Finally, when the selector 15 is in a third control position, POS 3, the selector 15 transmits a flight speed signal, for example an analog signal, to the controller 30 to control an operation of the combustion engine 10 at at least one flight speed. The combustion engine 10 at idling speed outputs an engine power less than the engine power output during flight speed, or even zero power.

In addition, the rotorcraft 1 comprises an arming button 20 connected to the controller 30 and able to transmit a signal, for example an analog signal, to this controller 30. The arming button 20 may be a monostable button or a bistable button.

According to another aspect, the rotorcraft 1 comprises at least one activation button 25 connected to the controller 30 and capable of transmitting a signal, for example an analog signal, to this controller 30. For example, the rotorcraft 1 comprises two activation buttons 26, 27 configured to be operable respectively by an instructor and a student. Reference sign 25 designates any activation button, while reference signs 26, 27 designate particular activation buttons if necessary. Furthermore, the activation button or buttons 25 are advantageously monostable buttons.

Furthermore, the rotorcraft 1 may comprise an alerter 95 connected to the controller 30 in order to generate an arming alert if necessary. The arming alert may be in the form of a visual alarm, for example emitting a light using a light-emitting diode or an equivalent, or one or more characters being displayed on a screen, an audible alarm, via a loudspeaker, and/or a haptic alarm, for example by means of a vibrating unit causing a member held or worn by an individual to vibrate.

FIG. 2 illustrates the method of the disclosure implemented by such a rotorcraft 1.

During a step STP0, the controller 30 controls the combustion engine 10 in order that this combustion engine 10 operates at the flight speed.

The method may then comprise a simulation phase PHASSIM to simulate the failure of the combustion engine 10.

This simulation phase PHASSIM then comprises arming, during a step STP1, the training mode by operating the arming button 20. The arming button 20 transmits a signal to the controller 30 to signal that the training mode is armed and therefore authorized. Optionally, the controller 30 transmits an alert signal, for example a digital signal, to the alerter 95 in order to generate, during a step STPAL, an arming alert using this alerter 95 as long as the training mode is armed. According to the example illustrated, the arming alert may take the form of displaying the message “TNGARM”.

Independently of the display of an arming alert, when the training mode is armed, the simulation phase PHASSIM then comprises a possible activation, during a step STP2, of the training mode by operating an activation button 25. The activation button 25 transmits a signal, for example an analog signal, to the controller 30 in order to activate the training mode. When the training mode is activated, the controller 30 consequently controls a deceleration of the combustion engine 10 to reach the idling speed, for example by controlling the fuel metering device according to a stored deceleration law. Optionally, the alerter 95 may display a message indicating the activation of the training mode on command from the controller 30.

To exit the training mode, the simulation phase PHASSIM comprises a deactivation, during a step STP3, of the training mode by operating the activation button 25 again. The activation button 25 transmits a deactivation signal to the controller 30 to deactivate the training mode. The controller 30 consequently controls an acceleration of the combustion engine 10 to reach a flight speed, for example by controlling the fuel metering device according to a stored acceleration law.

At this stage, a new operation of the activation button 25 will have no effect. Indeed, the training mode can only be reset by operating the arming button 20 again.

Optionally and in particular in the presence of a monostable arming button 20, the deactivation of the training mode may in fact induce the disarming of the training mode. A new application of the arming button 20 then makes it possible to initiate a new simulation phase by arming a new training mode.

If not, the simulation phase PHASSIM may require disarming of the training mode, during a step STP4, by operating the arming button 20. After the arming STP1 of the training mode, the second operation of the arming button 20 induces the disarming STP4 that ends the simulation phase PHASSIM. Following the second operation of the arming button 20, the arming button 20 transmits the disarming signal, for example an analog signal, to the controller 30. If the combustion engine 10 is at the idling speed, then the controller 30 controls, following the disarming, an acceleration of the combustion engine 10 to reach the flight speed. It should be noted that a disarming step STP4 can also be carried out after arming or activating the training mode if necessary.

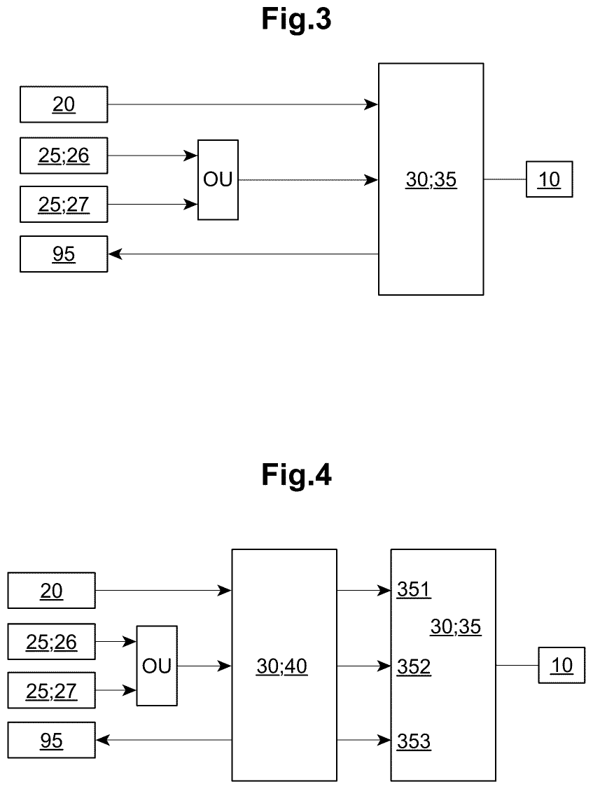

FIGS. 3 to 13 illustrate various embodiments.

According to FIG. 3, the controller 30 comprises an engine computer 35 controlling the combustion engine 10. For example, the combustion engine is a turboshaft engine and the engine computer may be a computer of a FADEC system. The selector 15, the arming button 20 and the activation button or buttons 25 are then connected to the engine computer 35, this engine computer 35 being configured to implement the above-mentioned steps of the simulation phase PHASSIM.

The term “computer” designates a processing unit that may, for example, comprise at least one processor and at least one memory, at least one integrated circuit, at least one programmable system, at least one logic circuit, these examples not limiting the scope given to the expression “processing unit”. The term “processor” may refer equally to a central processing unit or CPU, a graphics processing unit or GPU, a digital signal processor or DSP, a microcontroller, etc.

According to FIG. 4, the controller 30 comprises an avionics computer 40 and an engine computer 35 controlling the combustion engine 10. The selector 15, the arming button 20 and the activation button or buttons 25 are then connected to the avionics computer 40, the avionics computer 40 communicating with the engine computer 35. For example, the avionics computer 40 transmits a signal either to a first input 351 of the engine computer 35 controlling the turning off of the combustion engine 10 when the combustion engine 10 is to be turned off, or to a second input 352 of the engine computer 35 controlling an idling operation of the combustion engine 10 when the combustion engine 10 is to operate at the idling speed, or to a third input 353 of the engine computer 35 when the combustion engine 10 is to operate at the flight speed, like a conventional flight selector.

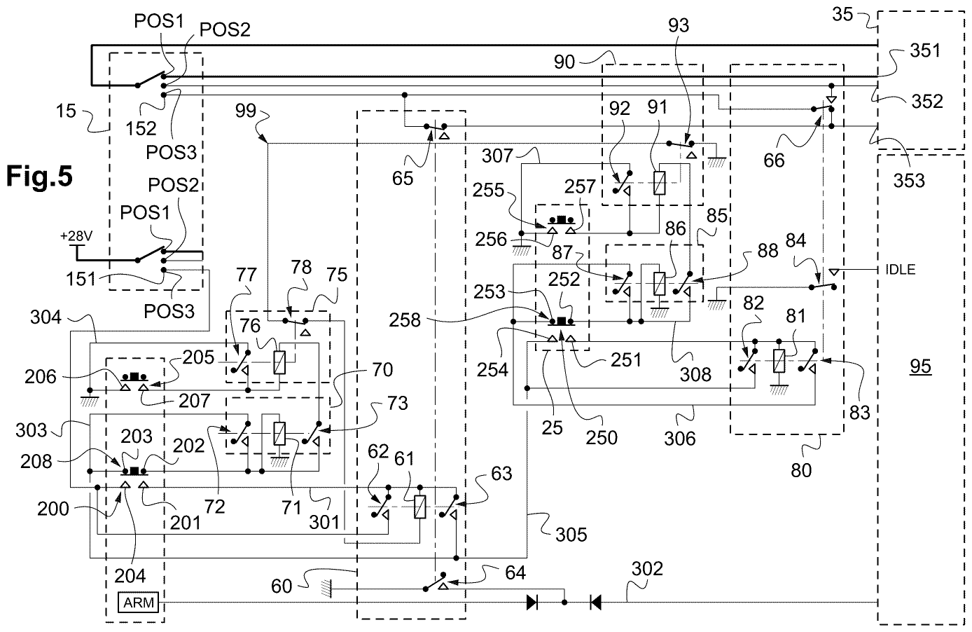

According to FIG. 5, the controller 30 comprises an electromechanical relay mechanism 50 and an engine computer 35 controlling the combustion engine 10.

The arming button 20 and the activation button 25 are connected to the electromechanical relay mechanism 50, the electromechanical relay mechanism 50 communicating with the engine computer 35 to control the engine speed to be implemented. For example, the electromechanical relay mechanism 50 is connected to a first input 351 of the engine computer 35 controlling the turning off of the combustion engine 10 when the combustion engine 10 is to be turned off, to a second input 352 of the engine computer 35 controlling an idling operation of the combustion engine 10 when the combustion engine 10 is to operate at the idling speed, and to a third input 353 of the engine computer 35 when the combustion engine 10 is to operate at the flight speed, like a conventional flight selector.

According to the example illustrated, the electromechanical relay mechanism 50 comprises six relays for this purpose.

In addition, the arming button 20 may, in a first arming position, close a first arming contact 200 and a second arming contact 205, and open a third arming contact 208. In a second position, the arming button 20 opens the first arming contact 200 and the second arming contact 205, and closes the third arming contact 208.

The first arming contact 200 comprises a first input arming terminal 204 electrically connected to a terminal 151 of the control selector 15 reached when the selector is in the third control position, POS3, and a first output arming terminal 201. The second arming contact 205 comprises input 206 and output 207 disarming terminals. Finally, the third arming contact 208 comprises a second input arming terminal 203 and a second output arming terminal 202.

Similarly, each activation button 25 closes, in a first position, a first activation contact 250 and a second activation contact 255, and opens a third activation contact 258. In a second position, each activation button 25 opens the first activation contact 250 and the second activation contact 255, and closes the third activation contact 258.

The first activation contact 250 comprises a first input activation terminal 254 and a first output activation terminal 251. The second activation contact 255 comprises input 256 and output 257 deactivation terminals. Finally, the third activation terminal 258 comprises a second input activation terminal 253 and a second output activation terminal 252.

The electromechanical relay mechanism 50 then comprises a first relay 60 provided with a first coil 61 electrically connected via a first electrical link 301 to the first output arming terminal 201 and to a disarming link 99 leading to an electrical ground. The first coil 61 closes, when electrically powered, a first primary contact 62 linking the first electrical link 301 to the first input arming terminal 204, a first secondary contact 63 linking the first electrical link 301 to a second relay 70 as well as to the second input arming terminal 203 and to the activation button 25, a first tertiary contact 64 linking the electrical ground to an alert link 302 leading to the alerter 95, and opens a first quaternary contact 65 arranged between a terminal 152 of the control selector 15 reached when the selector is in the third control position POS3 and the input 353 of the engine computer 35.

The second relay 70 is provided with a second coil 71 electrically connected to the second output arming terminal 202 and to the electrical ground. The second coil 71 closes, when electrically powered, a second primary contact 72 arranged on an electrical link 303 linking the second input arming terminal 203 to the second output arming terminal 202, and a second secondary contact 73 linking the second output arming terminal 202 to a third relay 75.

In particular, the third relay 75 is provided with a third coil 76 electrically connected to the output disarming terminal 207 and to the second output arming terminal 202 via the second secondary contact 73. The third coil 76 closes, when electrically powered, a third primary contact 77 arranged on an electrical link 304 to connect together the input 206 and output 207 disarm terminals, and opens a fourth secondary contact 78 arranged on the disarming link 99.

Therefore, a fourth relay 80 is provided with a fourth coil 81 electrically connected to the first output activation terminal 251 and to the electrical ground. The first input activation terminal 254 is electrically connected to the first output arming terminal 201, via an electrical link 305 reaching the first secondary contact 63, and to the second input arming terminal 203. The fourth coil 81 closes, when electrically powered, a fourth primary contact 82 linking the first output activation terminal 251 to the electrical link 305, a fourth secondary contact 83 linking the first output activation terminal 251 to the fifth relay 85 via an electrical link 306, and opens a fourth tertiary contact 84 connected to the alerter 95 as well as a fourth quaternary contact 66 arranged between a terminal 152 of the selector reached in the third control position POS3 and the third input 353 of the engine computer 35.

The fifth relay 85 is provided with a fifth coil 86 electrically connected to the second output activation terminal 252 by an intermediate link 308 and to the electrical ground. The fifth coil 86 closes, when it is electrically powered, a fifth primary contact 87 connected to the intermediate link 308 and to the electrical link 306 linked to the second input activation terminal 253, and a fifth secondary contact 88 connected to the intermediate supply link 308 and to a sixth relay 90.

The sixth relay 90 is provided with a sixth coil 91 electrically connected to the output deactivation terminal 257 and to the second output activation terminal 252 via the fifth secondary contact 88. The sixth coil 91 closes, when electrically powered, a sixth primary contact 92 connected to the input deactivation terminal 256 via an electrical link 307 and to the output deactivation terminal 256, and opens a sixth secondary contact 93 arranged on the disarming link 99.

In this context, FIG. 5 illustrates the electromechanical relay mechanism 50 when the control selector 15 is in the first control position, POS1.

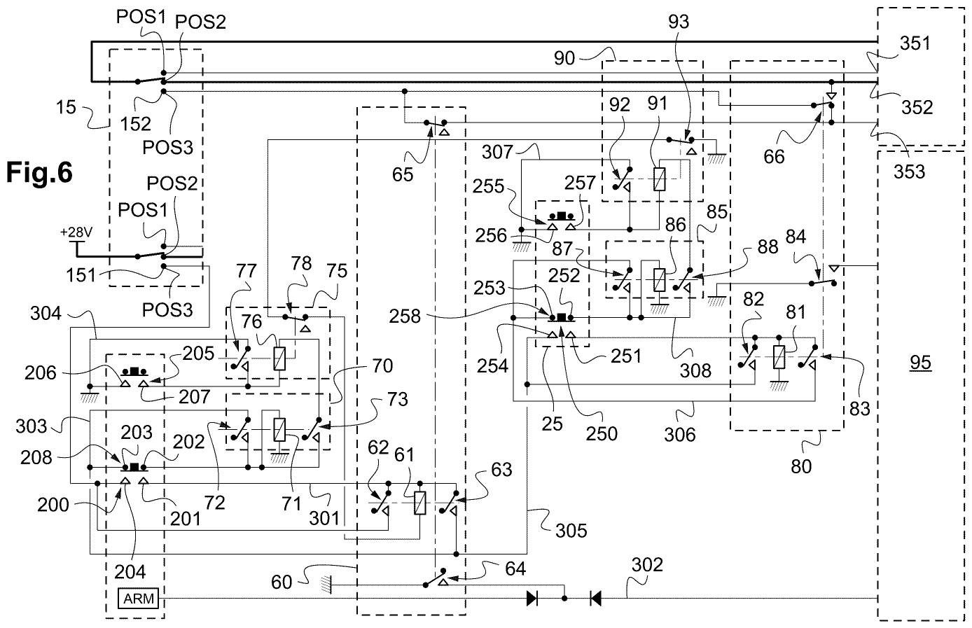

In FIG. 6, the control selector 15 is in the second control position POS2 and directly transmits an analog signal to the input 352 of the engine computer 35.

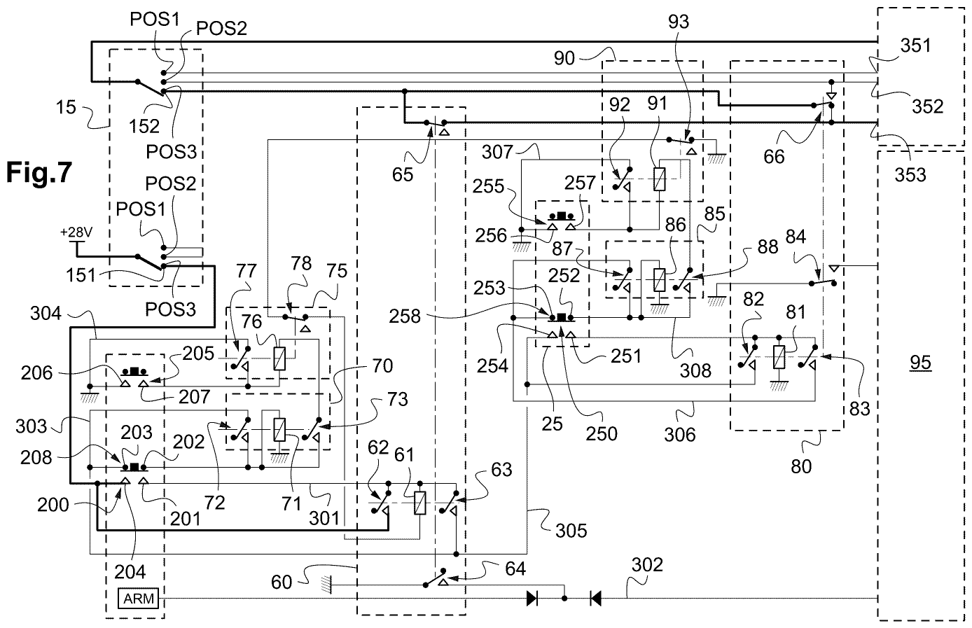

In FIG. 7, the control selector 15 is in the third control position, POS3, and directly transmits an analog signal to the first input arming terminal 204 and the input 352 of the engine computer 35 via the first quaternary contact 65 and the fourth quaternary contact 66.

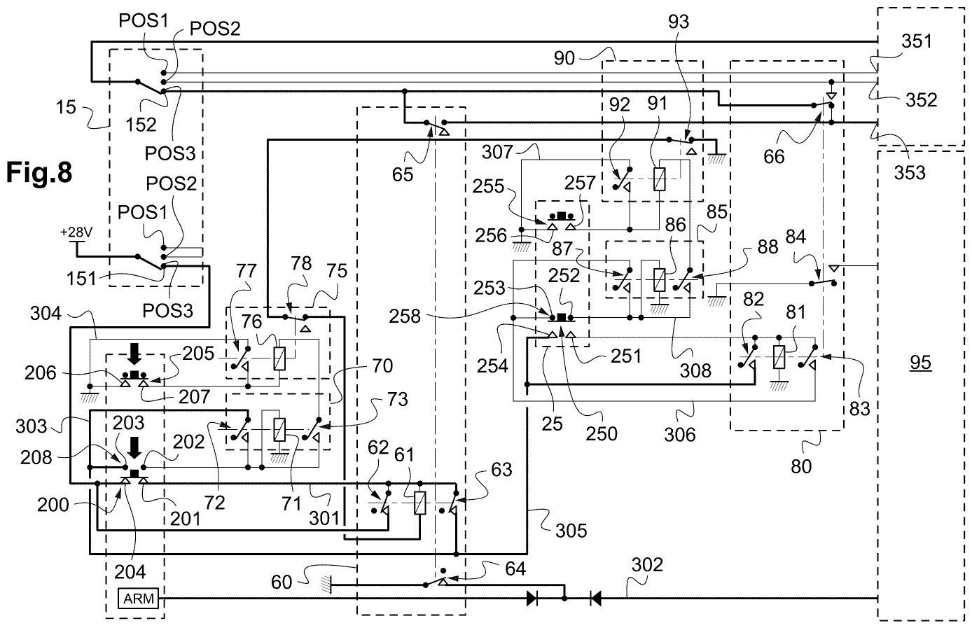

In FIG. 8, a pilot presses the arming button 20 that moves to its first position. The first coil 61 is electrically powered so as to close the first primary contact 62, the first secondary contact 63 and the first tertiary contact 64, and to open the first quaternary contact 65. The engine computer 35 then always receives a signal at its input 353 via the fourth quaternary contact 66. The training mode is then armed.

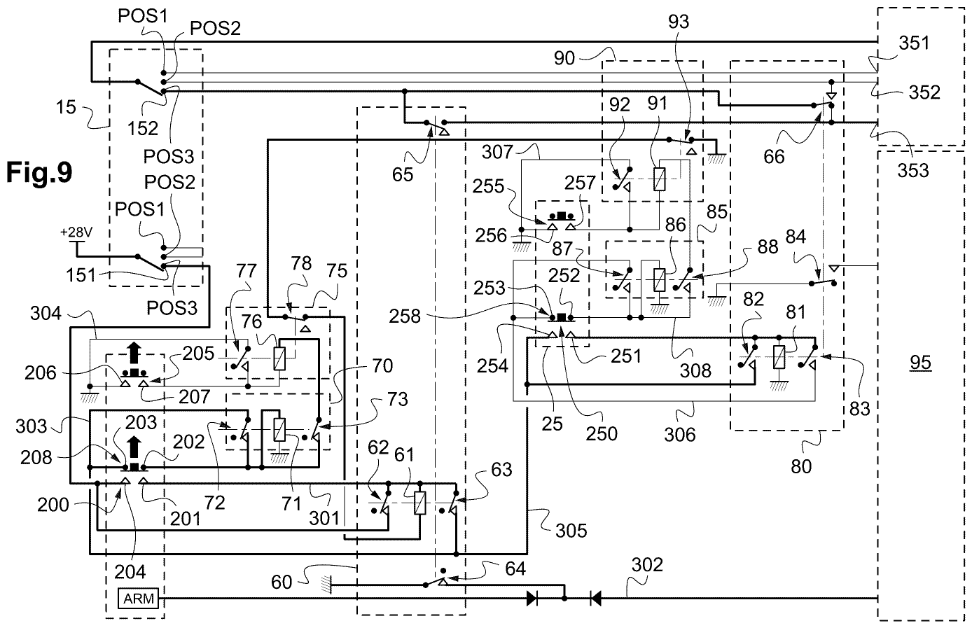

In FIG. 9, the arming button 20 is released and reaches its second position. The first coil 61 remains electrically powered. Moreover, the second coil 71 is also electrically powered and closes the second primary contact 72 and the second secondary contact 73. The training mode remains armed.

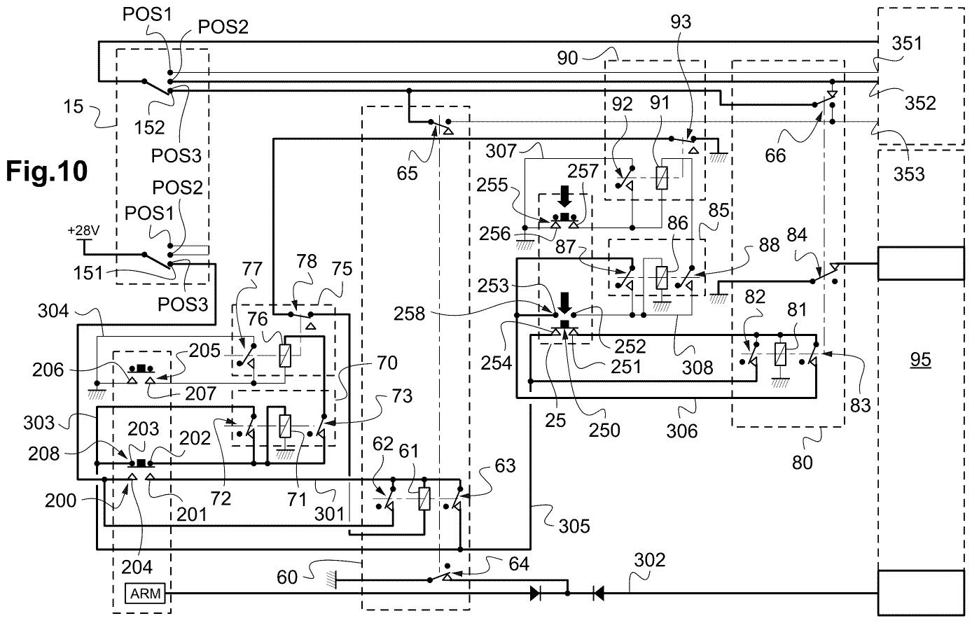

According to FIG. 10, a pilot presses an activation button 25 in order to simulate an engine failure. The fourth coil 81 is electrically powered so as to close the fourth primary contact 82, the fourth secondary contact 83 and the fourth tertiary contact 84, and to open the fourth quaternary contact 66. The engine computer 35 then receives a signal at its input 352 via the fourth quaternary contact 66. The training mode is activated. The alerter 95 may signal that the combustion engine is set to idling.

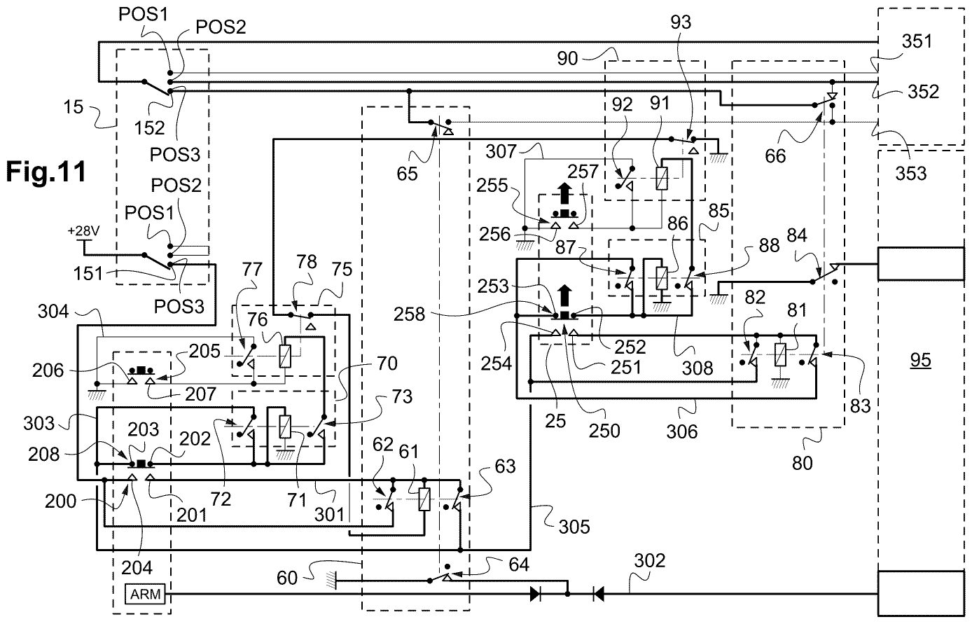

In FIG. 11, the activation button 25 is released. The fourth coil 81 remains electrically powered. The training mode remains activated.

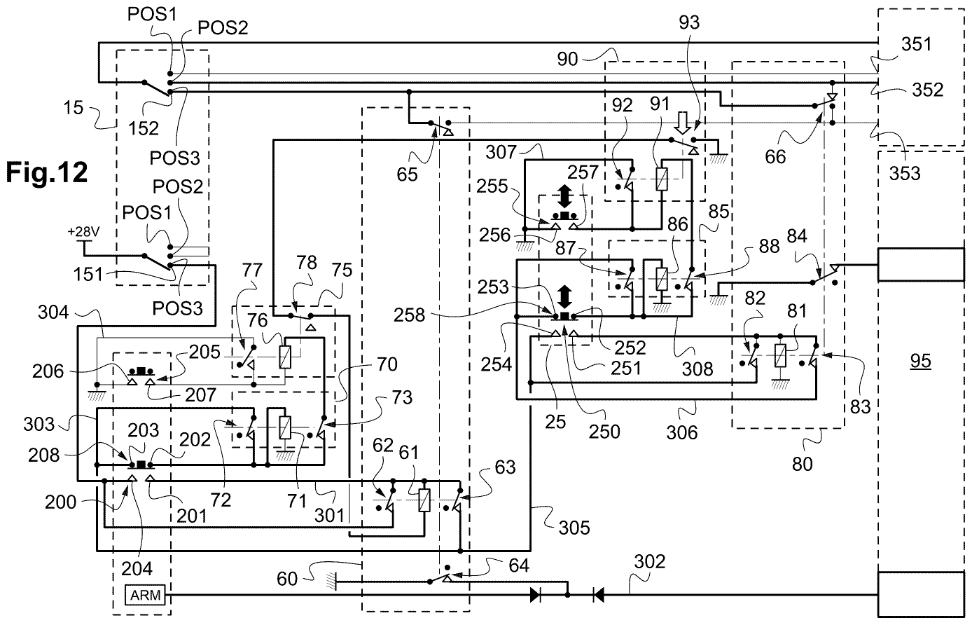

According to FIG. 12, a pilot presses an activation button 25 to deactivate the training mode. The sixth coil 91 is electrically powered so as to close the sixth primary contact 92, and to open the sixth secondary contact 93. The training mode is thus deactivated.

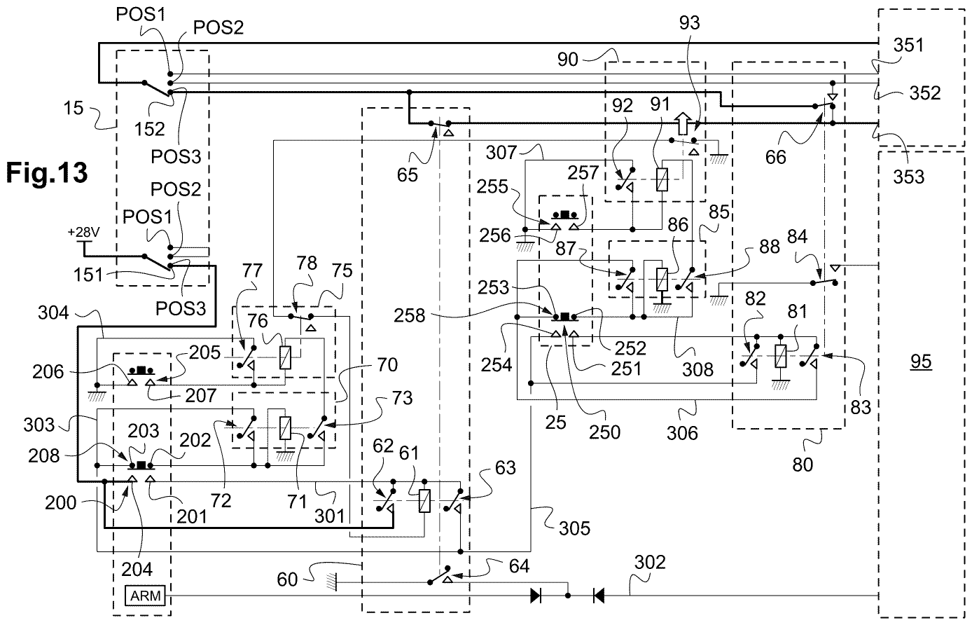

According to FIG. 13, when a monostable arming button 20 is present, the system then returns to the configuration of FIG. 7, the training mode being disarmed. When a bistable arming button 20 is present, pressing the arming button 20 enables the training mode to be disarmed.

Naturally, the present disclosure may be subjected to numerous variations as to its implementation. Although several embodiments are described above, it should readily be understood that it is not conceivable to identify exhaustively all the possible embodiments. It is of course possible to replace any of the means described with equivalent means without going beyond the ambit of the present disclosure.

What is claimed is:

1. A method for simulating a failure of a combustion engine of a single-engine rotorcraft, the rotorcraft comprising a controller controlling the combustion engine, the combustion engine being able to operate on command from the controller in a nominal mode at at least one flight speed in order to provide a driving power to at least one rotor, the combustion engine being able to operate on command from the controller at an idling speed,
wherein the method comprises a simulation phase comprising the following steps:
arming a training mode by operating an arming button in communication with the controller, the controller controlling an operation of the combustion engine at the at least one flight speed, the training mode not being able to be activated in the absence of the arming of the training mode;
subject to the arming of the training mode, activating the training mode by operating an activation button that is in communication with the controller and is different from the arming button, the controller consequently controlling a deceleration of the combustion engine to reach the idling speed; and
deactivating the training mode by operating the activation button again, the controller consequently controlling an acceleration of the combustion engine to reach the at least one flight speed, the training mode being able to be reset only during a new simulation phase.

2. The method according to claim 1,
wherein the simulation phase comprises disarming by operating the arming button at any time after the arming of the training mode, the disarming ending the simulation phase, and if the combustion engine is at idling speed, then, following the disarming, the controller controls an acceleration of the combustion engine in order to reach the at least one flight speed.

3. The method according to claim 1,
wherein the method comprises generating an arming alert with an alerter as long as the training mode is armed.

4. A single-engine rotorcraft comprising a single combustion engine for setting in motion a drive chain connected to at least one rotor, the rotorcraft comprising a controller controlling the combustion engine, the combustion engine being able to operate on command from the controller in a nominal mode at at least one flight speed in order to provide a driving power to at least one rotor, the combustion engine being able to operate on command from the controller at an idling speed,
wherein the rotorcraft comprises an arming button and at least one activation button connected to the controller in order to implement the method according to claim 1.

5. The rotorcraft according to claim 4,
wherein the rotorcraft comprises an alerter connected to the controller in order to generate an arming alert following the arming of the training mode.

6. The rotorcraft according to claim 4,
wherein the rotorcraft comprises two activation buttons configured to be operable respectively by two pilots.

7. The rotorcraft according to claim 4,
wherein the at least one activation button is a monostable button.

8. The rotorcraft according to claim 4,
wherein the at least one arming button is a monostable button or a bistable button.

9. The rotorcraft according to claim 4,
wherein the controller comprises an engine computer controlling the combustion engine, the arming button and the activation button communicating with the engine computer in order to implement the simulation phase.

10. The rotorcraft according to claim 4,
wherein the controller comprises an avionics computer and an engine computer controlling the combustion engine, the arming button and the activation button communicating with the avionics computer, the avionics computer communicating with the engine computer in order to implement the simulation phase.

11. The rotorcraft according to claim 4,
wherein the controller comprises an electromechanical relay mechanism and an engine computer controlling the combustion engine, the arming button and the activation button communicating with the electromechanical relay mechanism, the electromechanical relay mechanism communicating with the engine computer in order to implement the simulation phase.

12. The rotorcraft according to claim 11,
wherein the arming button closes a first arming contact and a second arming contact in a first arming position, the arming button closing a third arming contact in a second arming position, the activation button closing a first activation contact and a second activation contact in a first activation position, the activation button closing a third activation contact in a second activation position, the electromechanical relay mechanism comprising:
a first relay provided with a first coil electrically connected to a first output arming terminal of the first arming contact;
a second relay provided with a second coil electrically connected to a second output arming terminal of the third arming contact;
a third relay provided with a third coil electrically connected to the second arming contact and to the second output arming terminal via a contact of the second relay controlled by the second coil;
a fourth relay provided with a fourth coil electrically connected to a first output activation terminal of the first activation contact, a first input activation terminal of the first activation contact being electrically connected to the first output arming terminal via a contact of the first relay controlled by the first coil;
a fifth relay provided with a fifth coil electrically connected to a second output activation terminal of the third activation contact; and
a sixth relay provided with a sixth coil electrically connected to an output deactivation terminal of the second activation contact and to the second output activation terminal via a contact of the fifth relay controlled by the fifth coil, an electrical disarming line being electrically connected to the first coil and comprising a contact of the third relay controlled by the third coil and a contact of the sixth relay controlled by the sixth coil.
